(19) United States
(12) Patent Application Publication
(10) Pub. No.: US 2008/0074983 A1
(43) Pub. Date: Mar. 27, 2008

(54) Optical Pickup Device

(75) Inventors: Ryoichi Kawasaki, Gunma (JP); Satoshi Sekiguchi, Chiba (JP)

Correspondence Address: FISH & RICHARDSON P.C., P.O. BOX 1022, MINNEAPOLIS, MN, 55440-1022, US

(73) Assignees: SANYO ELECTRIC CO., LTD., Osaka (JP); SANYO OPTEC DESIGN CO., LTD., Tokyo (JP)

(21) Appl. No.: 11/862,083

(22) Filed: Sep. 26, 2007

(30) Foreign Application Priority Data
Sep. 27, 2006 (JP) 2006-262090

(51) Int. Cl. G11B 7/00

(52) U.S. Cl. 369/112.12

(57) ABSTRACT

An optical pickup device for reading a signal recorded in an optical disc including a first signal recording layer and a second signal recording layer, comprising: a laser diode configured to emit laser light; and a diffraction grating configured to be applied with laser light emitted from the laser diode, and to generate a main beam including zero order light, and a sub beam including plus first order light and minus first order light, such that a ratio of light amount of the sub beam to that of the main beam is substantially 1:7.

### CROSS-REFERENCE TO RELATED APPLICATION

This application claims the benefit of priority to Japanese Patent Application No. 2006-262090, filed Sep. 27, 2006, of which full contents are incorporated herein by reference.

### BACKGROUND OF THE INVENTION

1. Field of the Invention

The present invention relates to an optical pickup device that performs an operation of reading a signal recorded in an optical disc.

2. Description of the Related Art

There are commonly available optical disc devices that can perform an operation of reading a signal by applying laser light from an optical pickup device onto a signal recording layer provided in an optical disc.

The operation of reading the signal recorded in the signal recording layer by means of the optical pickup device is performed by applying the laser light emitted from a laser diode onto the signal recording layer to detect a change of the laser light reflected from the signal recording layer by using a photodetector.

Reading the signal recorded in the signal recording layer by using laser light requires a focusing control operation that focuses the laser light on the signal recording layer and a tracking control operation that allows the laser light to follow a signal track provided in a spiral shape in the signal recording layer.

There is a variety of methods for performing the focusing control operation, but the astigmatic method is commonly employed. There is also a variety of tracking control methods, but the three-beam method using a main beam and two sub beams is commonly employed. Since the astigmatic method employed for the focusing control operation and the three-beam method employed for the tracking control operation are both well known, the description thereof is omitted here.

In addition, recently there have been commercialized optical discs including not one, but two signal recording layers and, also optical pickup devices that read the signal recorded in the signal recording layers provided in such optical discs.

When an operation of reading the signal recorded in a two-layer type optical disc is performed, the focusing control operation and tracking control operation are performed for the signal recording layer that is being read. However, there is a problem that an offset of the tracking error signal or amplitude fluctuation occurs and thereby tracking control operation becomes unstable, due to the so-called stray light, i.e., laser light reflected from the signal recording layer that is not being read, which stray light is applied to the photodetector for generating a tracking error signal used for the tracking control operation.

In order to resolve this problem, there has been developed technology employing an optical disc device including an optical pickup device which performs subtraction processing on the signals obtained from the two photodetectors to eliminate the affect from the stray light. (See Japanese Patent Laid-open No. 1997-161295)

The prior art described in the above-mentioned patent reference is an improvement of an optical disc device including an optical pickup device. If there exists variation in the characteristics of the photodetectors etc. included in the optical pickup device, it becomes difficult to handle the variation thereof on the optical disc unit side. This problem is responsibility of optical pickup device manufacturing enterprise and improvement in the characteristics is expected.

### SUMMARY OF THE INVENTION

An optical pickup device according to an aspect of the present invention, which reads a signal recorded in an optical disc including a first signal recording layer and a second signal recording layer, comprises: a laser diode configured to emit laser light; and a diffraction grating configured to be applied with laser light emitted from the laser diode, and to generate a main beam including zero order light, and a sub beam including plus first order light and minus first order light, such that a ratio of light amount of the sub beam to that of the main beam is substantially 1:7.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a perspective view showing main parts of an optical pickup device according to an embodiment of the present invention;

FIG. 2 is a diagram illustrating an operation according to an embodiment of the present invention;

FIG. 3A and FIG. 3B are diagrams illustrating relationship between laser light and a photodetector included in an optical pickup device according to an embodiment of the present invention; and

FIG. 4 is a perspective view showing an example of a diffraction grating according to an embodiment of the present invention.

### DETAILED DESCRIPTION OF THE INVENTION

At least the following details will become apparent from descriptions of this specification and of the accompanying drawings.

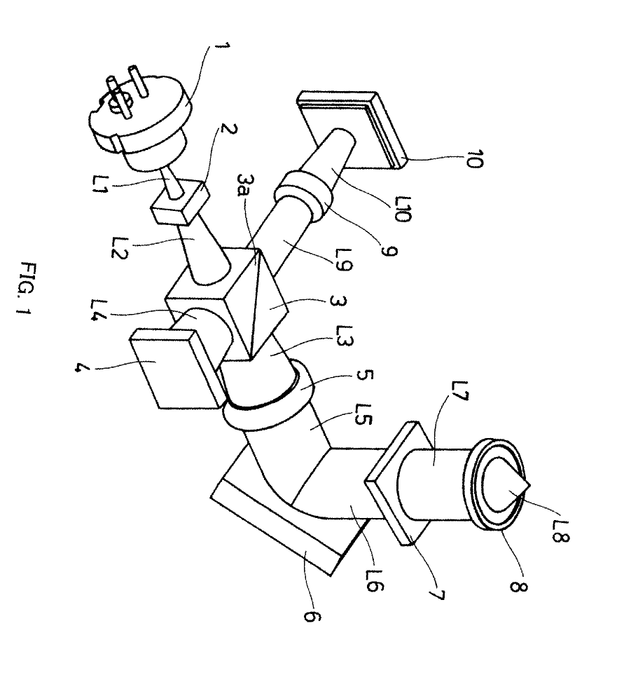

First, a configuration of an optical pickup device is now described with reference to FIG. 1. In FIG. 1, 1 represents a laser diode that emits laser light L1 whose power corresponds to a drive signal supplied from a laser drive circuit where the laser light L1 is laser light with an oval shaped cross section.

2 represents a diffraction grating to be applied with the laser light L1 from the laser diode 1, and the diffraction grating has a function of generating and emit laser light L2 including zero order light that is a main beam and plus first order and minus first order light that are sub beams.

3 represents a polarizing beam splitter to which the laser light L2 from the diffraction grating 2 is emitted. The polarizing beam splitter 3 is provide with a reflection film 3a which passes therethrough the laser light L3 to be applied to an optical disc (not shown) and which reflects the monitor laser light L4 to be applied to a front monitor diode 4 provided in order to control laser light power. The reflection film 3a is so configured as to have a function of reflecting thereon the return light, which is reflected from the optical disc, to become control laser light, as described later.

5 represents a collimator lens to which the laser light L3 passed through the reflective film 3a of the polarizing beam splitter 3 is emitted, and the collimator lens has a function of converting the incident laser light L3 into laser light L5 which is parallel light. 6 represents a reflection mirror onto which the laser light L5 is emitted, and the reflection mirror 6 has a function of reflecting all of the laser light L5 in the direction of the optical disc, which becomes laser light L6. Such reflection mirror 6 is generally called a rising mirror.

7 represents a ¼ wavelength plate to which the laser light L6 reflected from the reflection mirror 6 is emitted to, and the ¼ wavelength plate 7 has a function of shifting the phase of the laser light L6 by ¼ wavelength. 8 represents an objective lens to which the laser light L7 passed through the ¼ wavelength plate 7 is emitted, and the objective lens 8 has a function of focusing the laser light L8 onto a signal recording layer included in the optical disc. Further, the objective lens 8 is configured to perform a focusing control operation by a displacement operation in the direction perpendicular to the signal layer of the optical disc and also to perform a tracking control operation by a displacement operation in the optical disc diameter direction. The objective lens that performs these operations is provided with four support wires that are displaceable, for example.

The laser light L8 applied to the signal recording layer of the optical disc by the objective lens 8 is emitted to the objective lens 8 as return light reflected from the signal recording layer. The return light emitted to the objective lens 8 is emitted to the polarizing light beam splitter 3 after passing through the ¼ wavelength plate 7, reflection mirror 6, and collimator lens 5.

Since the return light emitted to the polarizing light beam splitter 3 has passed to and fro through the ¼ wavelength plate 7, or more specifically, since it has passed through the ¼ wavelength plate 7 twice as described above, the phase of the return light is shifted by ½ wavelength. In this way, when the return light with the shifted phase is emitted to the polarizing beam splitter 3, it is reflected as control laser light L9 by the reflective film 3a provided in the polarizing beam splitter 3.

9 represents a sensor lens to which the control laser light L9 reflected from the reflection film 3a of the polarizing beam splitter 3 is emitted, and the sensor lens 9 is operable to apply the control laser light L9 as concentrated light L10 onto the photoreception area provided in a photodetector 10, which is called a PDIC.

In the optical pickup device shown in FIG. 1, the laser light L1 from the laser diode 1 is emitted to the objective lens 8, after passing through the diffraction grating 2, polarizing beam splitter 3, collimator lens 5, reflection mirror 6, and ¼ wavelength plate 7, to be applied onto the signal recording layer of the optical disc by the focusing operation of the objective lens 8.

The laser light L8 applied on the signal recording layer is reflected from the signal recording layer to be emitted to the objective lens 8 as return light. The return light emitted to the objective lens 8 is emitted to the polarizing beam splitter 3 after passing through the ¼ wavelength plate 7, reflection mirror 6, and collimator lens 5.

The return light emitted to the polarizing beam splitter 3 is reflected from the reflective film 3a provided in the polarizing beam splitter 3, to become the control laser light L9. The control laser light L9 obtained in this manner is emitted to the sensor lens 9 and also is radiated as concentrated laser light L10 onto the photoreception area provided in the photodetector 10.

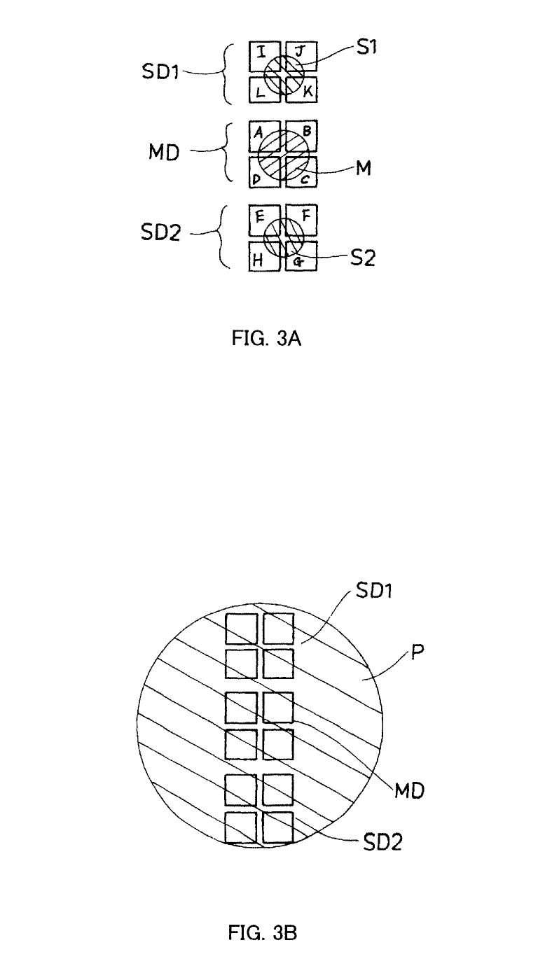

As shown in FIG. 3A, the photoreception area provided in the photodetector 10 is applied with the main beam, which is the zero order light, and includes: a main beam photoreception area MD used for the signal reproduction operation and focusing control operation; a leading sub beam photoreception area SD1 to which the leading sub beam S1 that is the plus first order light is applied and which is used for the tracking control operation; and a following sub beam photoreception area SD2 to which the following sub beam S2 that is the minus first order light is applied and which is used for the tracking control operation.

Each of the main beam photoreception area MD, the leading sub beam photoreception area SD1, and the following sub beam photoreception area SD2 includes 4 split sensors as shown in the diagram. This configuration is such that the signal recorded on the optical disc is read as a reproduced signal by adding a signal corresponding to the light volume of the main beam applied to all of the sensors A, B, C, and D constituting the main beam photoreception area MD.

Further, the configuration is such that a focus error signal is generated by adding the signals obtained from a pair of sensors in one diagonally opposed relationship of the 4 split sensors constituting the main beam photoreception area MD, and then by subtracting from the above addition signal an addition signal resulted from adding the signals obtained from a pair of sensors in the other diagonally opposed relationship, thereby a focusing control operation is performed using the focus error signal.

As described above, a reproduction operation and a focusing control operation are performed by the signal obtained from the main beam photoreception area MD. Next, the tracking control operation will be described. The tracking control operation is performed by the leading sub beam S1 irradiation operation on the leading sub beam photoreception area SD1 and the following sub beam S2 irradiation operation on the following sub beam photoreception area SD2.

For example, a configuration is such that a tracking error signal is generated by: adding the signals obtained from the two sensors I and J positioned at the top of the 4 split sensors constituting the leading sub beam photoreception area SD1, and then subtracting from the above addition signal an addition signal resulted from adding the signals obtained from the two sensors L and K positioned at the bottom thereof, to obtain the first control signal; adding the signals obtained from the two sensors E and F positioned at the top of the 4 split sensors constituting the following sub beam photoreception area SD2, and then subtracting from the above addition signal an addition signal resulted from adding the signals obtained from the two sensors H and G positioned at the bottom thereof, to obtain the second control signal; and operating the first control signal and the second control signal obtained in this manner.

Recently, in order to improve accuracy, in addition to the above tracking control operation, there is employed a method of performing a tracking control operation by using not only the above tracking error signal from the sub beams S1 and S2 but also a tracking error signal obtained from a main beam photoreception area MD applied with the main beam M, which method is called differential push-pull.

The tracking error signal according to this method is so configured as to be obtained by subtracting: the sub tracking error signal obtained from the leading sub beam photoreception area SD1 and the following sub beam photoreception area SD2; from the main tracking error signal obtained from the main beam photoreception area MD.

This will be described with reference to the sensor area codes which are shown in the diagram. If the main tracking error signal is named as MTE, then MTE=(A+B)−(C+D), and if the sub tracking error signal is named as STE, then STE={(E+F)−(G+H)}+{(I+J)−(L+K)}.

Also, the tracking control operation using the differential push-pull method is performed based on the differential push-pull signal DPP, and this DPP signal is obtained from the equation DPP=MTE−k*STE. Here, k is a constant.

In this way, there has been developed an optical pickup device that performs a tracking control operation using only sub beams, and a tracking control operation using a sub beam and main beam combination.

The laser light L1 emitted from the laser diode 1 is emitted to the polarizing beam splitter 3 as laser light L2 that has been diffracted by the diffraction grating 2, and a portion of this laser light is reflected from the reflection film 3a to be applied onto the front monitor diode 4 as monitor laser light L4.

The monitor laser light 4 applied to the front monitor diode 4 is changed according to the power level of the laser light L1 emitted from the laser diode 1. Therefore, there can be performed a laser servo operation of controlling the power of the laser light L1 emitted from the laser diode 1 so as to be maintained at a predetermined value, by feeding back the monitor signal generated by the front monitor diode 4 to the drive circuit which is provided for supplying the drive signal to the laser diode 1.

As described above, the focus error signal is generated from the signal obtained from the main beam photoreception area MD, and then based on this focus error signal the focusing control operation is performed. Such a focusing control operation is performed by displacing the objective lens 8 in the direction perpendicular to the signal surface of the optical disc D.

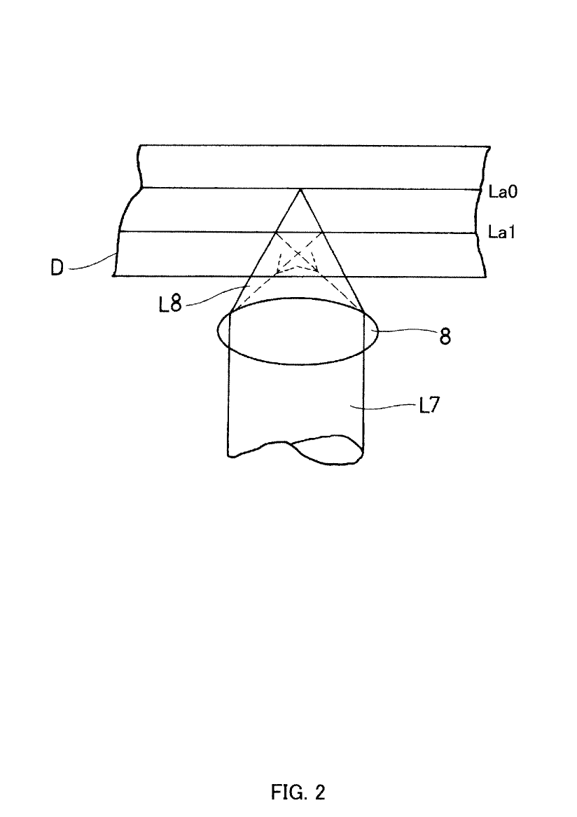

FIG. 2 shows the relationship between a first signal recording layer La0 and a second signal recording layer La1, which are provided in the optical disc D and the objective lens 8, and the state shown in the diagram is a state when the laser light L8 is focused on the first signal recording layer La0. That is, in such a state, the laser light L8 is focused on the first signal recording layer La0, where the tracking control operation is performed for the signal track (recording track) provided in the first signal recording layer La0 and the signal recorded in the first signal recording layer La0 is reproduced.

To reproduce the signal recorded in the second signal recording layer La1, the objective lens 8 is displaced downward from the position shown in FIG. 2 to focus the laser light L8 on the second signal recording layer La1.

The optical pickup device according to the present invention is configured as described above, and next, a gist of the present invention, specifically measures against stray light for the tracking control operation, will be described.

First, an adverse effect of stray light on conventional optical pickup devices is described. As shown in FIG. 2, when the signal recorded in the first signal recording layer La0 is reproduced, the laser light L8 constituting the main beam M, leading sub beam S1, and following sub beam S2 generated by the diffraction grating 2 is applied to the first signal recording layer La0.

Then, each of the main beam M, leading sub beam S1, and following sub beam S2 is reflected from the first signal recording layer La0 and subsequently pass through the objective lens 8, ¼ wavelength plate 7, reflection mirror 6, and collimator lens 5, to be emitted to the reflective film 3a of the polarizing beam splitter 3. In this way, as described above, the incident laser light is reflected from the reflection film 3a of the polarizing beam splitter 3 to be emitted to the sensor lens 9 as control laser light L9.

The control laser light L9 emitted to the sensor lens 9 is applied as concentrated laser light L10 to the photoreception area provided in the photodetector 10 by the light concentrating operation of the sensor lens 9. FIG. 3A shows the relationship between the concentrated laser light L10 radiated in this manner and the photoreception area, and as shown in the diagram, the main beam M, the leading sub beam S1, and the following sub beam S2 are respectively applied onto the main beam photoreception area MD, the leading sub beam photoreception area SD1, and the following sub beam photoreception area SD2.

As a result of the main beam M, the leading sub beam S1, and the following sub beam S2 being respectively applied onto the main beam photoreception area MD, the leading sub beam photoreception area SD1, and the following sub beam photoreception area SD2, a focusing control operation on the first signal recording layer La0 and a tracking control operation on the signal track provided in the first signal recording layer La0 are performed. Thereby, reproduction of the signal recorded in the first signal recording layer La0 can be performed.

As described above, the laser light L8 is applied onto first signal recording layer La0 of the optical disc D by the focusing operation of the objective lens 8, and the main beam M in the laser light L8 is reflected as stray light from the second signal recording layer La1 as shown in FIG. 2 by the broken line. In this way, the stray light reflected from the second signal recording layer La1 passes through the objective lens 8, ¼ wavelength plate 7, reflection mirror 6, and collimator lens 5 and is emitted onto the reflective film 3a of the polarizing beam splitter 3, in the same manner as the laser light reflected from the first signal recording layer La0 does.

In this way, the stray light that is emitted to the reflective film 3a of the polarizing beam splitter 3 is reflected from the reflective film 3a and then passes through the sensor lens 9 and is applied onto the photoreception area provided in the photodetector 10. Since this stray light is not focused laser light such as the light reflected from the first signal recording layer La0, it is not concentrated onto the photoreception area by the sensor lens 9.

FIG. 3B shows the relationship between the main beam photoreception area MD, the leading sub beam photoreception area SD1, and the following sub beam photoreception area SD2 and the stray light, where the diagonally shaded area P is an area on which the stray light beam is applied.

As is clear from the diagram, the stray light beam is applied onto the main beam photoreception area MD, the leading sub beam photoreception area SD1, and the following sub beam photoreception area SD2 provided in the photodetector 10. The light amount of the main beam M applied onto the main beam photoreception area MD is sufficiently greater than the light amount of the stray light beam, so it does not have an adverse effect on the signal generation operation of the main beam photoreception area MD, or more specifically, on the reproduction operation of the signal recorded on the first signal recording layer La0 or generation operation of the focus error signal.

On the other hand, the light amount of the leading sub beam S1 and the following sub beam S2 that are applied to generate the tracking error signal in the leading sub beam photoreception area SD1 and the following sub beam photoreception area SD2 is set to be smaller than that of the light amount of the main beam M, that is, the ratio of the light amount of the stray light to that of the leading sub beam S1 and following sub beam S2 is relatively greater. As a result, there becomes significantly great an effect of applying the stray light generated from the main beam M reflected from the second signal recording layer La1 to the leading sub beam photoreception area SD1 and the following sub beam photoreception area SD2, and thereby the problem of unstableness of tracking control operation occurs.

The zero order light, which is the main beam, plus first order light, and minus first order light, which are the sub beams reproduced by the diffraction grating 2, and the light amount ratio, or more specifically, the light amount ratio between one of the sub beams and the main beam, is generally set to 1:15. Therefore, the sub beam reflected as stray light from the second signal recording layer La1 is relatively smaller in light amount than the main beam reflected as stray light, thereby an effect on the tracking control operation can be ignored.

There will be described the relationship between the sub beams S1 and S2 reflected from the first signal recording layer La0 and the stray light of the main beam reflected from the second signal recording layer La1, assuming that the ratio between the light amount of the sub beam and light amount of the main beam generated by a conventional diffraction grating 2 stands at 1:15.

In addition, the optical disc D is provided with the first signal recording layer La0 and the second recording layer La1, where the transmittance and reflectance of the second signal recording layer La1 are assumed to be T1 and R1, respectively, the reflectance of the first signal recording layer is assumed to be R0. Further, the ratio of the surface area of the photoreception area of the photodetector 10 to the surface area of the P area on which the stray light beam is applied is assumed to be a.

Optical discs D, where the reflectance R0 of the first signal recording layer La0 is set at 21%, the transmittance T1 of the second signal recording layer La1 is set at 85%, and the reflectance R1 is set at 15%, have been commercialized, and such optical discs D will be described. In addition, the description will be given assuming that the surface area ratio a for the optical pickup device is 0.012.

First, assuming that the normal light amount of the main beam, or more specifically, the amount of the light reflected from the first signal recording layer La0 is Im, then Im=1×T1×R0×T1, and the value is 0.152. Further, assuming that the normal light amount of the sub beam, or more specifically, the amount of the light reflected from the first signal recording layer La0 is Is, then Is=1/(1+15+1)×T1×R0×T1, and the value is 0.0089.

Next, assuming that the light amount of the main beam reflected from the second signal recording layer La1, or more specifically, the light amount of the stray light is In, then In=1×R1, and the value is 0.15.

Assuming that the light amount ratio of the stray light to the main beam normal light quantity Im is αm, then αm=In/Im×a, and the value is 0.012.

In addition, assuming that the light amount ratio of In, which is the light amount of the stray light, to Is, which is the normal light amount of the sub beam is αs, then αs=In/Is×a, and the value is 0.202.

In this way, the light amount ratio αs that is the ratio of In, which is the light amount of the stray light, to Is, which is the normal light amount of the sub beam used for the tracking control operation performed to reproduce the signal recorded in the first signal recording layer La0, is approximately 20%. This ratio is considerably large, and thus it is possible to perform the tracking control operation with stability.

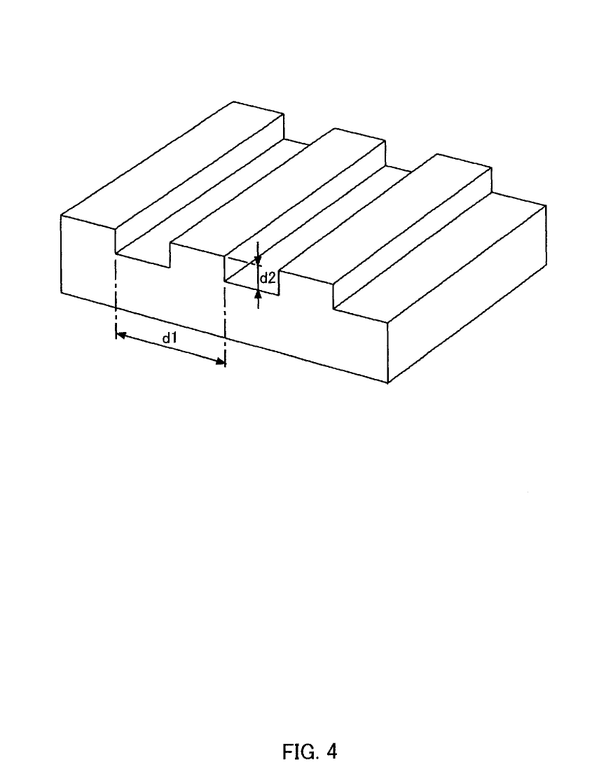

The present embodiment employs a light amount ratio between the sub beam and the main beam generated by the diffraction grating 2 of 1:7, to improve such points as above. The setting of this light amount ratio can be realized by improving the depth of the grooves (groove portions) in the grating comprising the diffraction grating 2. FIG. 4 is a perspective view showing an example of the diffraction grating 2 of FIG. 1. The diffraction grating 2 is provided with a grating shaped in periodically repetitive rectangular peaks and valleys as oriented in reference to the surface which in the drawing is the upper side, to generate the zero order light, plus first order light, and minus first order light. Here, the length of 1 period of peaks and valleys is d1, and the difference in height between a peak and a valley is the groove depth d2. The sub beam and main beam light amount ratio of 1:7 is realized by setting the groove depth d2 suitably.

Assuming that the sub beam normal light amount, or more specifically, the amount of the light reflected from the first signal recording layer La0 when the light amount ratio is set in this manner is Iss, Iss=1/(1+7+1)×T1×R0×T1, and the value is 0.0166.

Assuming that the ratio of In, which is the light amount of the stray light, to Iss, which is the sub beam normal light quantity is αss, then αss=In/Iss×α, and the value is 0.107.

Here, the light amount ratio αss, which is the ratio of In, the light amount of the stray light, to Iss, which is the normal light amount of the sub beam used to perform the tracking control operation to reproduce the signal recorded in the first signal recording layer La0, is approximately 10%, and it has been proved that with this light amount ratio it is possible to perform the tracking control operation with stability.

It is thereby made possible to resolve the malfunction problem of tracking control due to stray light generated when the signal recorded in a multiple layer optical disc is reproduced.

In an optical pickup device according to this embodiment, the light amount ratio between the sub beam and main beam is set to stand at 1:7, so that it is possible to keep low the light amount of the stray light that is reflected from the other signal recording layer of the two-layer type optical disc when the signal recorded in one signal recording layer thereof, thereby it is possible to perform a tracking control operation with stability.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. An optical pickup device for reading a signal recorded in an optical disc including a first signal recording layer and a second signal recording layer, comprising:
a laser diode configured to emit laser light; and
a diffraction grating configured
to be applied with laser light emitted from the laser diode, and
to generate a main beam including zero order light, and a sub beam including plus first order light and minus first order light, such that a ratio of light amount of the sub beam to that of the main beam is substantially 1:7.

2. The optical pickup device according to claim 1, wherein
the diffraction grating includes a groove portion to make the ratio of light amount of the sub beam to that of the main beam to be substantially 1:7.

3. The optical pickup device according to claim 2, wherein
the groove portion has such a depth that the ratio of light amount of the sub beam to that of the main beam is substantially 1:7.

4. The optical pickup device according to claim 1, further comprising:
a photodetector, wherein
when the photodetector is applied with the sub beam reflected from one signal recording layer for which a focusing control operation is being performed, the one signal recording layer being either the first signal recording layer or the second signal recording layer,
a tracking control operation is performed to allow the main beam to follow a recording track in the one signal tracking layer, based on a tracking error signal obtained from the photodetector.

5. The optical pickup device according to claim 4, wherein
A ratio of: light amount of the main beam that is reflected from the other signal recording layer for which the focusing control operation is not being performed, to be emitted to the photodetector; to
light amount of the sub beam that is reflected from the one signal recording layer, to be emitted to the photodetector,
is substantially 10%.
